(19) United States
(12) Patent Application Publication
(10) Pub. No.: US 2006/0075665 A1
(43) Pub. Date: Apr. 13, 2006

(54) License plate screw guard

(76) Inventors: Peter V. Lee, Honolulu, HI (US); Amberle Masuda, Honolulu, HI (US)

Correspondence Address: Donald W. Meeker;Patent Agent, 924 East Ocean Front #E, Newport Beach, CA, 92661, US

(21) Appl. No.: 10/963,151

(22) Filed: Oct. 12, 2004

(51) Int. Cl. G09F 7/00

(52) U.S. Cl. 40/202

(57) ABSTRACT

A license plate screw guard shields the screws that attach a license plate to a vehicle. The guard is made of soft stretchable rubberized plastic of approximately ⅛″ thickness, and thicker directly over the license plate screws or injection molded plastic with multiple front layers pivotally interconnected by living hinges. The guard fits over the top of the license plate and covers the two plate attaching screws. The front surface of the guard covers the width of the license plate thereby providing a surface for imprinting information. Alternately two guards each cover one of the screws.

### BACKGROUND OF THE INVENTION

1. Field of the Invention

This invention relates to an impact pad for absorbing forces, and more particularly to a license plate screw guard to fit over the top of a license plate with a front guard over the license plate screws to prevent the screws from damaging the bumpers of other vehicles in low impact contacts or collisions.

2. Description of the Prior Art

A large amount of automobile collision property damage in low-impact rear-end automobile collisions is caused by the two protruding screws in the upper front license plate and license plate cover. There are hundreds of various types of license plate covers but no device currently on the market that protects against damage caused by the two screws that hold those covers in place. Frequently, in low impact collisions, the only visible resulting property damage are the puncture or scratch marks on the rear bumper that are caused by those protruding screws. The entire rear bumper has to be replaced at a cost of many hundreds of dollars per case, ultimately costing the insurance industry and drivers millions of dollars.

Many prior art patents concerning license plates provide protection from theft or damage to the plate. Some do provide screw covers that would impede an attempt of theft, but would not provide much protection against damage during a collision.

Prior art U.S. Pat. No. 2,827,722, issued Mar. 25, 1958 to Leclerc, provides a one piece protective frame for license plates. This clear molded plastic frame is inexpensive to manufacture and designed to provide an ornamental safety protective rim with means for resiliently snapping the frame directly onto the license plate. The license plate in effect supports and mounts the frame. The frame protects the license plate and maintains it clear and clean while at the same time protecting an operator for injury as result of collision or impingement on the edges of the license plate, as in washing the car, etc.

Prior art U.S. Pat. No. 2,921,395, issued Jan. 19, 1960 to Fishman, shows a license plate holder that forms a protective covering for the license plate. The holder is made from molded plastic in one piece and is economical to manufacture and easy to install.

Prior art U.S. Pat. No. 3,470,787, issued Oct. 7, 1969 to Mackie, claims a protective cap that has a sealant material therein which when applied to a fastener effectively excludes air and retards corrosion. In one embodiment it includes a corrosion indicator which will signal the start of any corrosion under the cap.

Prior art U.S. Pat. No. 6,481,126, issued Nov. 19, 2002 to Paulhill, describes a lockable license plate holder for securing a license plate via a plurality of conventional fasteners to a vehicle. The license plate holder includes a license plate holder housing member provided with an open generally rectangular framework element having an upper portion and a lower portion provided with a plurality of apertured mounting tabs dimensioned to receive the conventional fasteners, and a locking unit including a lock member operatively connected to a pair of locking arms provided with a plurality of cover tabs that will selectively cover and expose the apertured mounting tabs in response to the position of the lock member. In addition, the interior of the open framework element is further provided with at least one bracket element that is dimensioned to surround a registration decal provided on most state license plates.

Prior art U.S. Pat. No. 6,243,977, issued Jun. 12, 2001 to Shuen, discloses a knockdown license plate frame. The frame includes upper, lower, left and right members that can be freely assembled as desired in order to improve the appearance of a license plate of a motorcycle or a car.

Prior art U.S. Pat. No. 6,006,459, issued Dec. 28, 1999 to Kosmach, indicates a transparent vehicle license plate cover member that has an outwardly projecting curved shape that exhibits distinctive performance advantages when mounted on the vehicle. The mounted cover enhances aerodynamic operation of the vehicle while reducing glare when viewing the covered license plate.

Prior art U.S. Pat. No. 5,950,339, issued Sep. 14, 1999 to Lucier, puts forth an improved license plate protector that comprises a one piece flexible cover made of relatively high impact strength polycarbonate resin, which remains substantially transparent and damage resistant even upon marring, scratching and weathering of the cover during use. The plate protector further comprises an improved structural technique for positioning and securing a one piece, light weight plate protector to a license plate and a motor vehicle, and protecting the license plate, through the combined use of a perimeter rib, retaining tabs, a plurality of positioning tabs, corresponding attachment locations and a plurality of attachment holes. A method of making a license plate protector as described comprises the steps of drying polycarbonate resin with a heater, and forming a license plate protector by application of heat and pressure to such resin in a molding device having mold surfaces comprising material selected from the group consisting of stainless steel and chrome plating.

Prior art U.S. Pat. No. 5,870,841, issued Feb. 16, 1999 to Brody, II, concerns a license plate holder provided with a flat backing plate to which a transparent cover is hinged at the base thereof and which may be readily removable from the backing plate at the top.

Prior art U.S. Pat. No. 5,381,618, issued Jan. 17, 1995 to Singleton, illustrates a security frame assembly for vehicle license plates that provides for the complete enclosure of the plate and any dated registration decals thereon in order to prevent or increase the difficulty of the theft thereof. The device comprises a peripheral frame with a tough transparent overlay, secured to the vehicle using standard threaded fasteners. The heads of the fasteners are concealed by caps that require the use of a special tool for their removal. The transparent overlay provides for the display of the complete plate, while also protecting the plate and registration sticker from easy theft. While a determined thief could take the plate and frame, the device would require additional time which would increase the risk of being apprehended for the thief and thus make the protected plate an unattractive risk. However, the device would permit the theft of the plate and frame without damage to the vehicle, thus saving the vehicle owner any potential repair costs. Advertising or other matter may be included on the periphery of the frame.

Prior art U.S. Pat. No. 4,891,895, issued Jan. 9, 1990 to DeLaquil, Jr., is for a license plate holder that provides a weather-proof and tamper-proof enclosure for a vehicle license plate. The holder includes a backing plate adapted for securing to the vehicle license plate mount and to have the license plate secured thereto. A cover frame is secured to the backing plate by means of tamper-resistant screws secured between the backing plate and frame without passing through the license plate or a transparent pane held against the license plate by the frame. Gaskets provide weather-proof seals between the frame and pane and between the license plate and pane. The tamper-resistant screws are received in cylindrical female-threaded fasteners that are crimped in place to determine the spacing between the frame and backing plate. The backing plate is provided with four mounting apertures corresponding to four standardly spaced mounting holes in the vehicle license plate mount. Two apertures may be covered by a removable plate having a lower edge adapted to be supported in a channel that is provided as part of certain vehicle license plate mounts.

Prior art U.S. Pat. No. 4,903,422, issued Feb. 27, 1990 to Varga, provides a license plate frame assembly that is designed for displaying and projecting a vehicle license plate or identification tag. The assembly includes a generally rectangular frame with a rearwardly extending wall portion and an open center portion. A transparent plate abuts the frame and is confined within the wall portion to cover the open center. A rear panel, also confined within the wall portion, sandwiches the license plate between the transparent plate and the rear panel. The frame is secured from the rear portion thereof, fasteners being extended through a generally planar surface thereof, thereby preventing its unauthorized removal.

Prior art U.S. Patent Application #20020078608, issued Jun. 27, 2002 to Paulhill, shows a lockable license plate holder for securing a license plate via a plurality of conventional fasteners to a vehicle. The license plate holder includes a license plate holder housing member provided with an open generally rectangular framework element having an upper portion and a lower portion provided with a plurality of apertured mounting tabs dimensioned to receive the conventional fasteners, and a locking unit including a lock member operatively connected to a pair of locking arms provided with a plurality of cover tabs that will selectively cover and expose the apertured mounting tabs in response to the position of the look member. In addition, the interior of the open framework element is further provided with at least one bracket element that is dimensioned to surround a registration decal provided on most state license plates.

Prior art U.S. Pat. No. D412,876, issued Aug. 17, 1999 to Crecelius, claims the ornamental design for a license plate holder.

Prior art U.S. Pat. No. 6,475,094, issued Nov. 5, 2002 to Bruns, describes a method of making a ultra high molecular weight polyethylene (UHMWPE) body combined with a bolt, a cap screw, a reinforcing member uses a compression molding machine equipped with a male and female mold set. Particulate UHMWPE dispensed into the cavity of the female mold surrounds the head of the bolt and screw and reinforcing member. Pressure and heat applied to the particulate UHMWPE molecularly bonds the UHMWPE to the bolt, screw, and reinforcing member.

Prior art U.S. Pat. No. 4,948,319, issued Aug. 14, 1990 to Day, discloses a screw/cap assembly that is formed by bonding an initially separate cap onto the head of a screw by means of an adhesive, such as an epoxy resin sufficiently strong to allow the screw to be driven while the cap is in place. The intention is that the manufacturer would maintain stocks of the caps and stocks of the screws of different types, and only secure predetermined caps onto the heads of predetermined screws in response to specific orders from customers.

Prior art U.S. Pat. No. 4,576,533, issued Mar. 18, 1986 to Chartier, indicates a cap of synthetic resinous material for securement over the head of a fastener, such as a bolt or screw type. The cap has a hollow head portion and a cap attachment portion. The head portion has a top wall and an integral annular side wall. The attachment portion is formed integral in the inner wall adjacent a circumferential free edge thereof and is constituted by an annular channel formed in the inner wall of the cap for receiving in snap-fit engagement therein a lower circumferential flange of a fastener head to secure the cap over the fastener head.

Prior art U.S. Pat. No. 4,944,644, issued Jul. 31, 1990 to Bell, puts forth a cover cap that is provided for a screw fastener device of the type comprising a threaded shank and a head. The screw fastener device also has a washer means below said head, said washer means including a rigid spreader washer located over a resilient washer part. The screw fastener device is especially intended to secure paneling, such as roof and wall cladding, in industrial and domestic buildings. The cover cap comprises a cap member for location over the fastener head, a peripheral wall of the cap member sealingly engaging said resilient washer part. Further the cap includes clip means for clipping to the fastener device below the rigid spreader washer to secure the cap on the screw fastener device. The clip means preferably comprises an annular series of indents, but alternatively the annular wall could include a peripheral skirt of indented U-form defining said clip means.

Prior art U.S. Pat. No. D313,787, issued Jan. 15, 1991 to Williams, concerns the ornamental design for a vehicle license plate cover.

What is needed is a simple inexpensive device for shielding the protruding screws on a license plate to prevent damage to bumpers of other vehicles in low impact collisions.

### SUMMARY OF THE INVENTION

An object of the present invention is to provide a license plate screw guard that will shield license plate screws to eliminate damage to vehicles normally caused by the screws in low-impact collisions.

An added object of the present invention is to provide a multiple layer license plate screw guard with the license plate screws recesses in slots and an additional protective outer layer over the recess for extra protection against screw damage from low impact collisions.

A related object of the present invention is to provide two open edge slots, one to receive the screw shaft and one to receive the head of the screw for easy mounting of the invention on a license plate by merely loosening the screws, sliding the slotted edge of the invention over the screws and tightening the screws to secure the guard in place.

Another related object of the present invention is to provide a flip up front guard plate connected by a living hinge to the rest of the invention so that it may be pivoted up to reveal the screws underneath for installation, removal, or adjustment of the invention.

A corollary object of the present invention is to provide the multiple layer license plate screw guard with living hinges separating at least two of the layers so that the guards can be mass produced by injection molding.

Another object of the present invention is to provide a license plate screw guard that comprises a waterproof guard to help protect top of license plate from rusting or denting.

One more object of the present invention is to provide a license plate screw guard that covers screws and prevents the screws from loosening, thereby preventing loss of a license plate.

An additional object of the present invention is to provide a license plate screw guard with a wide front surface useful for imprinting information, such as slogans or logos for advertising or personalizing purposes.

A further object of the present invention is to provide a license plate screw guard that is capable of being mass produced by a molding process and manufactured in a wide array of colors, thereby suiting an individual vehicle owner's preferences.

In brief, the license plate screw guard is preferably mass produced by injection molding using a plastic colored to match a vehicle or license plate with several hinged layers for better shock absorption. It may also be made of a soft stretchable rubberized plastic of approximately ⅛″ thickness, although it may be ¼″ thick or more directly over the license plate screws. The device will be available in many different of colors, including clear, black and every other possible color. The front surface of the guard covers the width of the license plate thereby providing a surface for imprinting information, such as customization to include company logos or different phrases. The measurements of the device will be approximately 12.5″ by 1.5″ by 0.5″ and shorter for two of the embodiments, as well as a third embodiment with two small screw covers just fitting over the screws. The device will be available in either an open or closed version, meaning the top of the license plate will be either fully enclosed or openly exposed. It may form a stretchable envelope which is tension fit over the top of the license plate to cover the screws but not cover the numbers and letters on the plate.

In a preferred injection molded multiple layer embodiment of the invention a preformed top inverted channel formed by a short back plate contacting flange, a longer front plate contacting flange, and an interconnecting top surface structured to fit over the top of a license plate. The bottom edge of the plate contacting flange has two edge slots just wide enough to receive a shaft of one of the screws in each slot. A second front surface, pivotally connected to the plate contacting surface along a bottom living hinge, has two mating edge slots to the plate contacting surface slots, the second front surface edge slots being wide enough to receive the head of each screw therein with the screws recessed down within the outer slot, so that the license plate screw guard of the present invention simply slides down over a pair of loosened license plate screws and the screws tightened to attach the license plate screw guard. A front guard surface layer is pivotally attached to the top of the second surface so that the guard surface layer is normally down over the license plate screws to protect against screw damage with the screw heads concealed below the front guard surface layer. The front guard surface layer is easily pivoted up for access to the screws to tighten or loosen the screws.

An advantage of the present invention is in reducing damage to vehicles in low-impact collisions.

Another advantage of the present invention is that it keeps license plate mounting screws from loosening.

An additional advantage of the present invention is to help protect top of license plate from rusting or denting.

One more advantage of the present invention is that it is easy to install on an existing license plate on a vehicle.

A further advantage of the present invention is that it provides a multi-layer strong shield to guard against screw damage.

One more advantage of the present invention is that it provides an area for imprinting.

Yet another advantage of the present invention is in being available in a wide array of colors.

Still one more advantage of the present invention is that it may be mass produced by injection molding.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a front elevational view of a license plate with the license plate screw guard of the present invention mounted over the top of the license plate;

FIG. 2 is a cross-sectional view taken through 2-2 of FIG. 1 showing the license plate screw guard on the top of the license plate;

FIG. 3 is a back elevational view of the license plate with the license plate screw guard of FIG. 1 showing the shorter back surface of the guard;

FIG. 4 is a front elevational view of a license plate with the license plate screw guard of the present invention mounted over the top of a license plate frame and the license plate;

FIG. 5 is a back elevational view of the license plate and license plate frame with the license plate screw guard of FIG. 4 showing the shorter back surface of the guard;

FIG. 6 is a front elevational view of an alternate embodiment of the license plate screw guard of the present invention as individual screw guards mounted over the top of the license plate and the screws;

FIG. 7 is a back elevational view of the license plate with the alternate embodiment of the license plate screw guard of FIG. 6 showing the screws inserted through the openings in the back surfaces of the guards;

FIG. 8 is a cross-sectional view taken showing the alternate embodiment of the license plate screw guard of FIG. 6 on the top of a license plate with no frame;

FIG. 9 is a front elevational view of an alternate embodiment of the license plate screw guard of the present invention as a single screw guard mounted over the top of a license plate and frame and over the screws and extending from just outside the screws inwardly between the screws across the upper license plate with a front area for indicia;

FIG. 10 is a back elevational view of the license plate with the alternate embodiment of the license plate screw guard of FIG. 9 showing the screws inserted through the openings in the back surface of the guard;

FIG. 11 is a cross-sectional view, taken through 11-11 of FIG. 9, showing the alternate embodiment of the license plate screw guard of FIG. 9 on the top of a license plate with no frame;

FIG. 12 is a front elevational view of a preferred embodiment of the license plate screw guard of the present invention having a pivotable front guard surface layer pivoted up for access to the screws underneath fitting within slots of a second layer with the heads of the screws holding down a plate contacting layer;

FIG. 13 is a front elevational view of a preferred embodiment of the license plate screw guard of FIG. 12 having the pivotable front guard surface layer pivoted down over the screws;

FIG. 14 is an exploded cross sectional view of the preferred embodiment of FIG. 12 taken through 14-14 of FIG. 13 showing the short back plate contacting layer and the front plate contacting surface layer and second surface layer and front guard surface layer against the second layer and also lifted in dashed lines for access to the screws by a screw driver head.

### BEST MODE FOR CARRYING OUT THE INVENTION

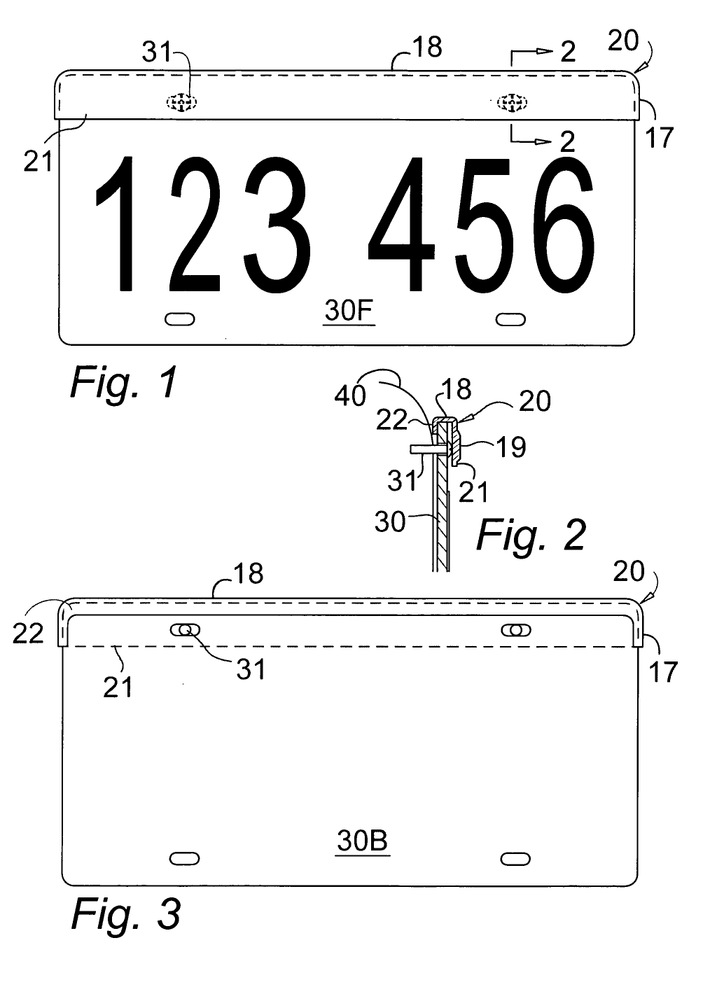

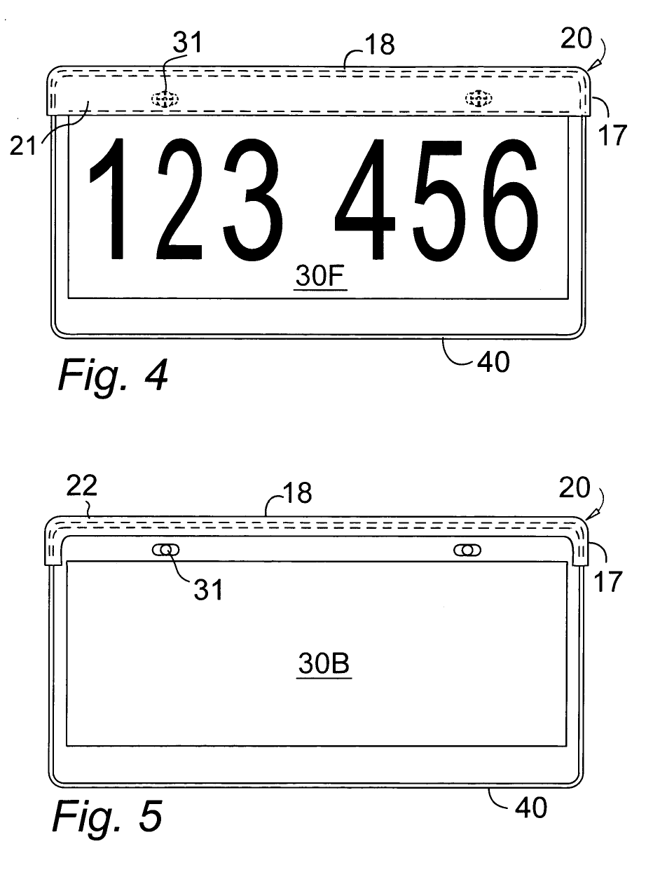

In FIG. 1-8 a license plate screw guard 20 and 20A shields the screws 31 that attach a license plate 30 to a vehicle 40. The preferred embodiment of the guard 20 of FIGS. 1-5 comprises a protective cover 20 that includes a front plate contacting surface 21 and back plate contacting surface 22 spaced apart by a distance less than the thickness of a license plate 30 for a motor vehicle 40.

The protective cover 20 further comprises a tension means, such as the top surface 18 or the side surfaces 17, that interconnect the front and back plate contacting surfaces 21 and 22. The tension means is capable of maintaining the front and back plate contacting 21 and 22 surfaces in tight contact with a front and back surface of the license plate 30F and 30B (as shown in FIG. 2) so the protective cover 20 is held in place on the license plate 30. The protective cover 20 further comprises a resilient surface means, preferably a thicker rubber padded front surface 19, for covering a pair of screws 31 that secure the license plate 30 to the motor vehicle 40. The cover 20 prevents the screws 31 from contacting a surface of another motor vehicle (not shown), and thereby preventing them from causing any damage to the bumper or other surface of another motor vehicle (not shown) upon a low-impact contact therewith.

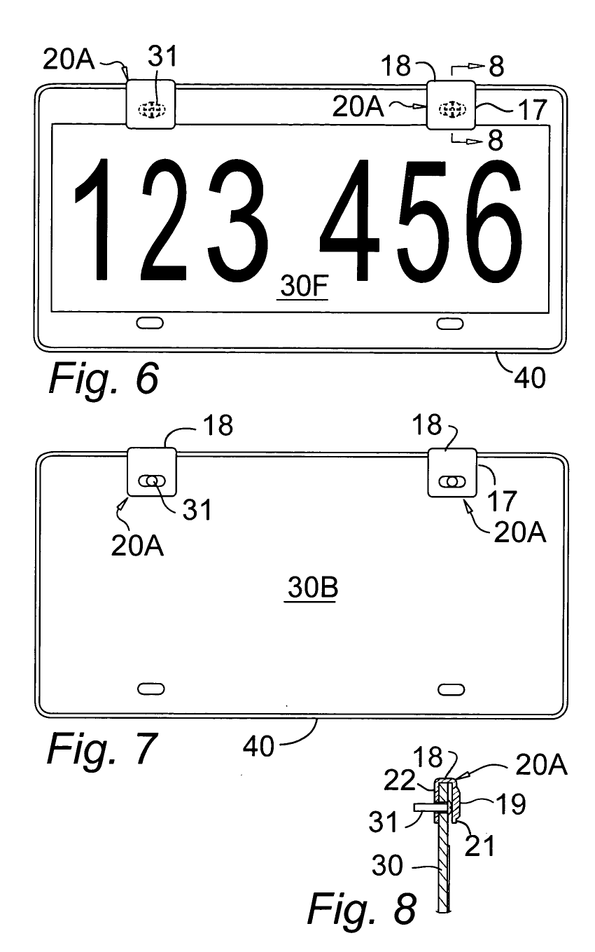

The protective cover 20 is manufactured from a rubberized material, which is formed into a single piece in the preferred embodiment of FIGS. 1-5 and the cover 20A is formed in two pieces in the alternate embodiment of FIGS. 6-8. The cover 20 comprises a front surface 21 and a back surface 22, and a top surface and side surfaces interconnect the front and back surfaces 21 and 22, forming a stretchable envelope which is tension fit over the top of the license plate. The front surface 21 is sufficiently wide to cover the pair of screws 31 of the license plate 30, thereby serving as the resilient surface means for covering the pair of screws 31. The front surface 21 also serves as the front plate-contacting surface. The back surface 22 serves as the back plate-contacting surface. The top surface and side surfaces serve as the tension means for maintaining the front and back plate contacting surfaces 21 and 22 in tight contact with a front and back surface of the license plate 30F and 30B, as shown in FIG. 1-3. The front surface 21 covers the width of the license plate 30 thereby providing a surface for imprinting information 16, such as a logo, on the front surface 21.

In FIGS. 6-8, the alternate embodiment of the screw guard 20A is formed by molding a rubberized material into two pieces, each comprising a front surface 21, a back surface 22, and a top surface 18 interconnecting the front and back surfaces, the front surface 21 of each of the two pieces being sufficiently wide to cover one of the screws of the license plate so that the front surfaces of the two pieces serve as the resilient surface means for covering the pair of screws. The front surface 21 of each of the two pieces also serves as the front plate contacting surface and the back surface 22 serves as the back plate contacting surface with the top surface 18 serving as the tension means for maintaining the front and back plate contacting surfaces in tight contact with a front and back surface of the license plate.

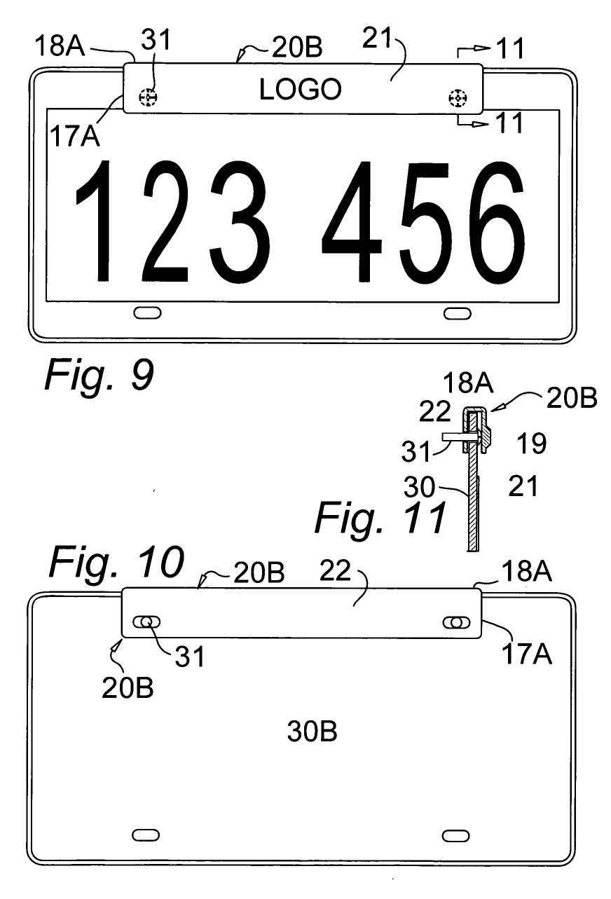

In FIGS. 9-11, the license plate screw guard 20B has a front surface layer 21 with a thick padded portion 19 that covers the screws and the license plate screw guard covers the space between the screws 31 on the front of the plate, thereby providing a surface for imprinting indicia, such as the LOGO of FIG. 9.

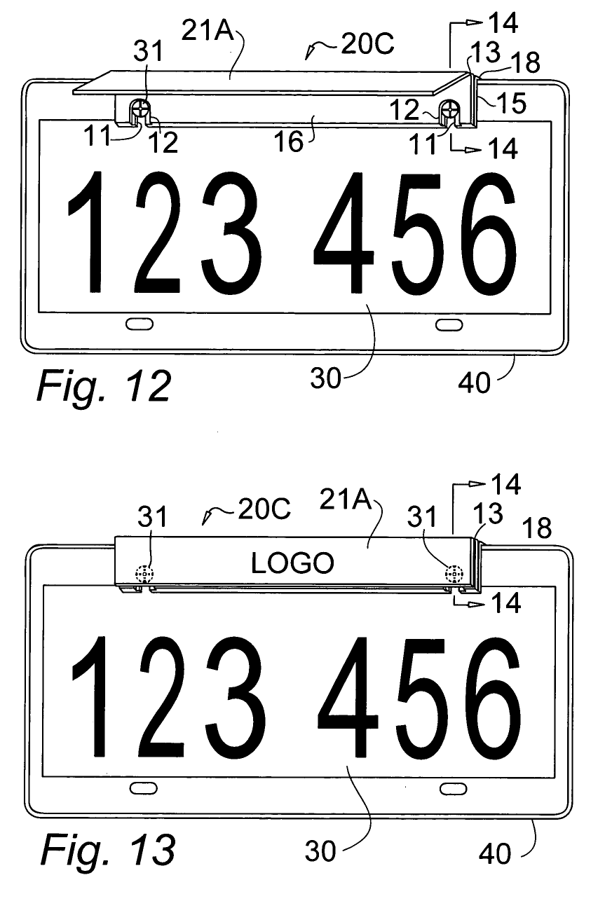

In FIGS. 12-14, the preferred embodiment of the license plate screw guard 20C is formed by injection molding a plastic material in a single sheet having a short back plate contacting layer 22 and multiple front layers 15, 16, and 19A interconnected by living hinges 13 and 14.

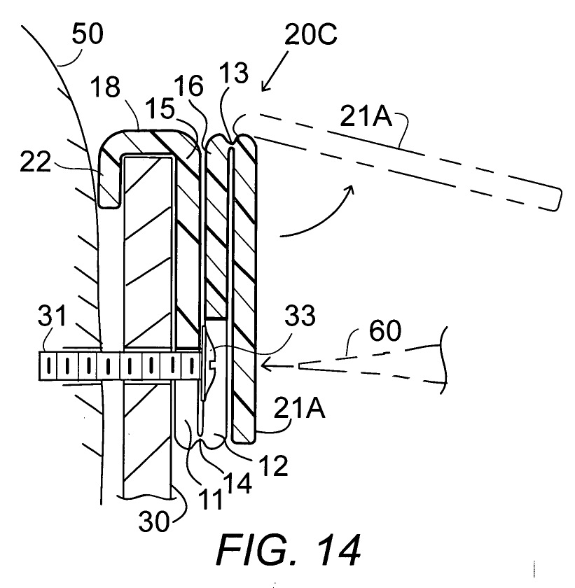

The preferred embodiment of the license plate guard 20C has a preformed top inverted channel formed by a short back plate contacting layer 22, a longer front plate contacting layer 15 , and an interconnecting top surface 18 structured to fit over a top of a license plate 30. A bottom edge of the front plate contacting layer has two edge slots 11 just wide enough to receive a shaft of one of the screws 31 in each slot, as seen in FIGS. 12 and 14. A second front surface layer 16 is pivotally connected to the front plate contacting surface 15 along an interconnecting bottom living hinge 14. The second front surface layer has two mating edge slots 12 sufficiently wide to receive a head 33 of a screw 31 therein. The head 33 of the screw 31 when tightened to the front plate contacting layer 15 is recessed down within the outer slot 12, so that the license plate screw guard 20C is adapted for sliding down over a pair of loosened license plate screws with the screws being received in the edge slots 11 and 12. An outer front guard surface layer 21A is pivotally attached to a top of the second surface 16 by an interconnecting living hinge 13 so that the outer front guard surface layer 21A is adapted to be normally positioned down over a pair of license plate screws 31 as in FIGS. 13 and 14, so that both the outer front guard surface layer 21A and the second front surface layer 16 both protect against screw damage. The outer front guard surface layer 21A is adapted for pivoting up for access to the screws 31 to tighten or loosen the screws by a screwdriver head 60, as shown in FIG. 14 by dashed lines.

The license plate screw guard 20 and 20A-20C could be custom ordered. The color and an imprinted slogan or logo, used for advertisement or to personalize the guard could be specified prior to manufacturing. The manufacturer would form the guard by molding a rubberized material into a single piece 20 and 20B or two pieces 20A or injection molding a plastic into a single piece 20C; the custom ordered color could be added to the rubberized or plastic material or the guard could be coated with a color after the guard is formed. The manufacturer could form the indicia in the mold or imprint the custom ordered logo or slogan on the front surface 21 of the guard.

In practice, a user would install the license plate 30 on the vehicle 40 by securing it tightly with at least two screws 31 at the top of the plate 30. The user would then hold the guard 20 with the shorter back side 22 toward the front of the vehicle 40 and the wider front side 21 away from the vehicle 40. The user would then push the guard 20 down in a sleeve-like fashion over the license plate 30, being sure to entirely cover the heads of the screws 31 as shown in FIG. 1-3. If the guard 20 is seated correctly on the license plate 30, the front surface 21 would be in contact with the front 30F of the license plate 30, and the back surface 22 in contact with the back 30B of the plate 30. The two piece screw guard 20A and short one piece screw guard 20B, alternate embodiments of the invention, would be installed with the screw installation so that the screw 31 would go through the back of the screw guard 20A and 20B as shown in FIGS. 7, 8, 10, and 11.

In the preferred embodiment of the license plate screw guard 20C of FIGS. 12-14, the screw guard 20C slides down over a pair of loosened license plate screws with the screws being received in the edge slots 11 and 12 and the front and back plate contacting surfaces 21 and 22 and interconnecting top surface 18 slid down onto a top of the license plate 30. With the outer front guard surface layer 21A lifted as shown dashed in FIG. 14, the head 33 of the screw 31 is tightened to the front plate contacting layer 15 with the head 33 of the screw recessed down within the outer slot 12. The outer front guard surface layer 21A is normally positioned down over a pair of license plate screws 31 as in FIGS. 13 and 14, so that both the outer front guard surface layer 21A and the second front surface layer 16 both protect against screw damage.

It is understood that the preceding description is given merely by way of illustration and not in limitation of the invention and that various modifications may be made thereto without departing from the spirit of the invention as claimed.

What is claimed is:

1. A license plate screw guard for shielding the screws which attach a license plate to a vehicle, the guard comprising:
a protective cover comprising a front and back plate contacting surfaces spaced apart by a distance less than the thickness of a license plate for a motor vehicle, the protective cover further comprising a tension means interconnecting the front and back plate contacting surfaces, the tension means capable of maintaining the front and back plate contacting surfaces in tight contact with a front and back surface of the license plate so that the protective cover is held in place on the license plate, and the protective cover further comprising a resilient surface means for covering a pair of screws which secure the license plate to the motor vehicle so that the screws are prevented from contacting a surface of another motor vehicle and thereby prevented from causing any damage to the surface of another motor vehicle upon a low-impact contact therewith.

2. The license plate screw guard of claim 1 wherein the protective cover is formed by molding a rubberized material into a single piece comprising a front surface, a back surface, and a top surface and side surfaces interconnecting the front and back surfaces, the front surface being sufficiently wide to cover the pair of screws of the license plate and thereby serving as the resilient surface means for covering the pair of screws, the front surface also serving as the front plate contacting surface and the back surface serving as the back plate contacting surface with the top surface and side surfaces serving as the tension means for maintaining the front and back plate contacting surfaces in tight contact with a front and back surface of the license plate.

3. The license plate screw guard of claim 2 wherein the resilient surface means for covering the pair of screws is thicker than the rest of the guard.

4. The license plate screw guard of claim 3 wherein the resilient surface means for covering the pair of screws comprises a rubberized pad.

5. The license plate screw guard of claim 2 wherein the screw guard is fabricated of a colored material to match a color of a vehicle.

6. The license plate screw guard of claim 2 wherein the front surface covers the width of the license plate thereby providing a surface for imprinting information.

7. The license plate screw guard of claim 2 wherein the front surface covers the screws and the space between the screws on the front, thereby providing a surface for imprinting information.

8. The license plate screw guard of claim 1 wherein the protective cover is formed by molding a rubberized material into two pieces, each comprising a front surface, a back surface, and a top surface interconnecting the front and back surfaces, the front surface of each of the two pieces being sufficiently wide to cover one of the screws of the license plate so that the front surfaces of the two pieces serve as the resilient surface means for covering the pair of screws, the front surface of each of the two pieces also serving as the front plate contacting surface and the back surface serving as the back plate contacting surface with the top surface serving as the tension means for maintaining the front and back plate contacting surfaces in tight contact with a front and back surface of the license plate.

9. The license plate screw guard of claim 1 wherein the protective cover is formed by injection molding a plastic material in a single sheet having a short back plate contacting layer and multiple front layers interconnected by living hinges.

10. The license plate screw guard of claim 1 wherein the protective cover comprises a preformed top inverted channel formed by a short back plate contacting layer, a longer front plate contacting layer, and an interconnecting top surface structured to fit over a top of a license plate, a bottom edge of the front plate contacting layer having two edge slots just wide enough to receive a shaft of one of the screws in each slot, a second front surface layer, pivotally connected to the front plate contacting surface along an interconnecting bottom living hinge, the second front surface layer having two mating edge slots sufficiently wide to receive a head of a screw therein with the head of the screw when tightened to the plate recessed down within the outer slot, so that the license plate screw guard is adapted for sliding down over a pair of loosened license plate screws with the screws being received in the edge slots, and an outer front guard surface layer pivotally attached to a top of the second surface by an interconnecting living hinge so that the outer front guard surface layer is adapted to be normally positioned down over a pair of license plate screws so that both the outer front guard surface layer and the second front surface layer both protect against screw damage, and the outer front guard surface layer adapted for pivoting up for access to the screws to tighten or loosen the screws.
